(19) United States
(12) Patent Application Publication
(10) Pub. No.: US 2016/0107897 A1
(43) Pub. Date: Apr. 21, 2016

(54) WATER RECOVERY AND CLEANING METHOD AND APPARATUS

(71) Applicants: Marc Antony Panzella, Huntington Beach, CA (US); Branden Robert Adkins, Fountain Valley, CA (US)

(72) Inventors: Marc Antony Panzella, Huntington Beach, CA (US); Branden Robert Adkins, Fountain Valley, CA (US)

(21) Appl. No.: 14/517,837

(22) Filed: Oct. 18, 2014

(51) Int. Cl. C02F 1/00; C02F 1/02

(52) U.S. Cl. CPC C02F 1/001; C02F 1/02; C02F 2103/002

(57) ABSTRACT

The invention relates to a novel method and apparatus for use in recovering recovered unused drinking water and liquids with high water content from related applications and reusing it in a manner which does not have the potential for contaminating existing water systems or violate EPA regulations. The recovery system may be installed within a commercial kitchen's existing plumbing and yet avoid comingling of recovered and city or well water. Thus, grey water is able to be recovered and reused once in a commercial setting which provides significant savings on water bills as well as serving water conservation.

### FIELD

The invention relates to a novel method and apparatus for use in recovering grey water from related applications and reusing it in a manner which does not have the potential for contaminating existing water systems or violate EPA regulations.

### BACKGROUND OF THE INVENTION

The invention most closely corresponds with USPTO Class 210/712 wherein Class 210 relates to liquid purification or separation and sub-class 722 includes recycling.

In its simplest form, the invention comprises a novel water and liquid recovery system wherein a user can dispose of water or sodas as in a restaurant setting and the disposed liquids are then cleaned and purified to a point of reuse in a pre-wash commercial dishwashing process.

The water use in most homes or businesses has long been thought of in terms of clean white water coming in and sewage, or black water, going out. Gray water, as the name implies, is something in between. By most domestic definitions, gray water is tap water soiled by use in dishwashers, washing machines, tubs, showers and bathroom sinks While such grey water is not considered sanitary, it is also not toxic and generally disease free. Gray water reclamation is the process by which households make use of gray water's potential instead of simply piping it into overburdened sewage systems with all the black water.

### THE INVENTION

### Summary, Objects and Advantages

According to the EPA, nearly 280 gallons per household per day is simply sent down the drain to typically already overburdened sewer systems. Many commercial businesses such as resorts expel a far greater amount. Not only is this an extreme waste, it also creates extraordinary water bills for a home or business. Significantly so in areas where water is not plentiful.

The main issue with grey water recovery and reuse in a commercial setting is that most state and federal regulations disallow the process due to potential contamination. Unlike black water, grey water has not come into contact with fecal matter. This is the primary contaminant which makes black water relatively useless as a recycled commodity for most applications. One of the keys to grey water recycling is not to allow the water to sit. Bacteria and contaminants can easily form in stagnant water. Systems available in the art presently are 1 limited to using grey water to perform functions such as flushing toilets, which is of course beneficial from a conservation standpoint, but has obvious limits. Being able to reclaim water from unused drinking water and high water content liquids, and using for rinsing dishes and cookware takes conservation and money savings to a higher level. One company, Water Recycling Systems provides a reclamation service to both consumers and commercial entities, but as mentioned previously, the reuse is limited to activities such as toilet flushing or land irrigation.

The inventive water recovery method and apparatus resolves not only the potential for reclaimed water becoming stagnant, it provides a process of purification so that the recovered water may be used in applications such as commercial dishwashing. The recovered water is used in a pre-rinse mode and then the dishes or cookware are run through a commercial dishwasher which in turn adheres to regulations regarding contaminants, filtration and temperature sanitization. The results are lower water bills, and more importantly, more water left in reservoirs and wells. In this day and age, the ecological aspect is crucial for commercial entities to observe as well as private homes.

Other companies, such as Process and Water require capturing rainwater to effect the reuse of grey water. Its system also requires a dye injection to direct the nature or reuse of recovered water (again, rainwater). The inventive method reuses water from capturing unused drinking water and beverages and prevents recovered water from cross contaminating city water which helps negate the regulatory issues for use in restaurants. The recovered water is targeted toward a pre-rinse cycle wherein the use applies to rinsing food debris from dishes prior to the actual commercial wash cycle. Since dishes are sanitized during a commercial washing cycle, the recovered water does not have the potential for contaminating dishes, cutlery or cookware washed in such a manner.

The inventive water recovery method and apparatus uses separate lines from the incoming city or well water of an establishment, and is directed toward a rinse station therein. Debris can be rinsed from cookware as well as the system receiving sodas or other liquids remaining in glasses and the filtered water is then reclaimed and routed to the rinse station of said establishment.

### BRIEF DESCRIPTION OF THE DRAWINGS

The invention is described in further detail by reference to nine (9) drawings sufficient in detail to describe the invention in which:

FIG. 1 is an overview of the water recovery system;

FIG. 2 is an illustration of the receiving receptacle and the filtering system;

FIG. 3 is a general depiction of the water filter encasement;

FIG. 4 is a general depiction of the system's water heater;

FIG. 5 is an illustration of the bypass valve which allows excess captured water overflow to drain;

FIG. 6 is a general depiction of the flow booster pump;

FIG. 7 is a general depiction of the system's pressure bladder;

FIG. 8 is a general depiction of the systems' purification filtration module; and

FIG. 9 is an illustration of a rinse station depicting dual water lines.

### DETAILED DESCRIPTION, INCLUDING BEST MODES OF CARRYING OUT THE INVENTION

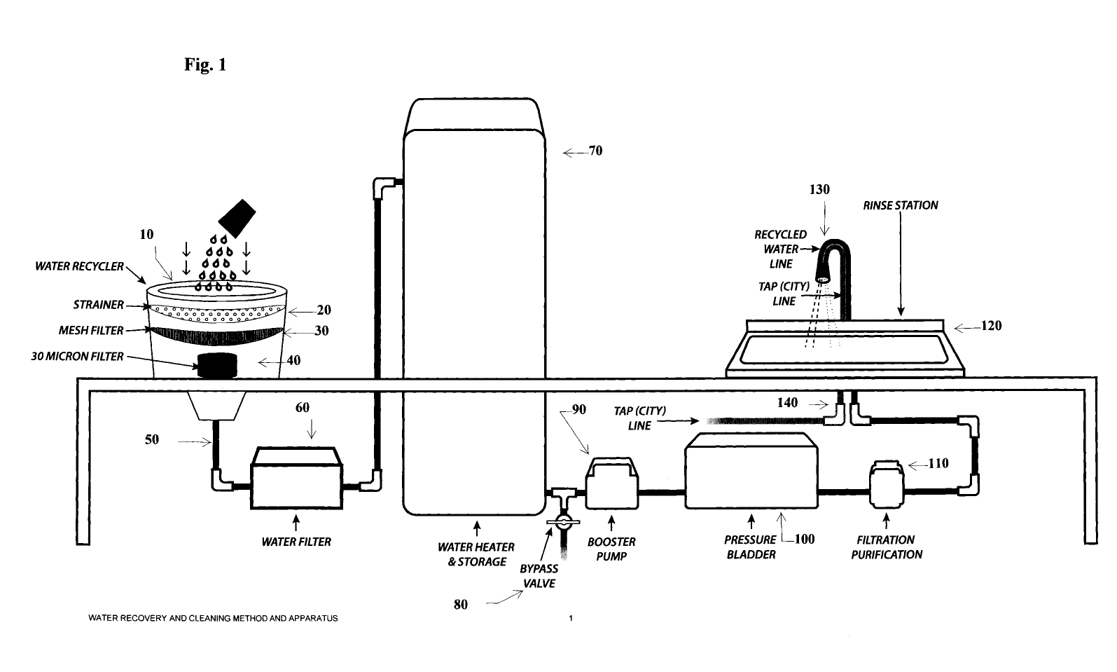

FIG. 1 illustrates an overview of the inventive water recovery and cleaning method and apparatus. The receiving recycler 10 is shown for intake of deposited liquids. A strainer 20 precedes first a mesh filter 30 and a thirty micron filter 40. An output line 50 takes filter water to a second filtration unit 60. Filtered water then goes into a heating and storage tank 70. A bypass valve 80 allows excess captured water, or overflow, to drain. An in-line booster pump 90 assists in pressured flow, and a pressure bladder 100 maintains a desired range of water pressure in the distribution system. A filtration purification module 110 sits in-line and precedes water travel to a rinse station 120. Once at the rinse station, either recovered water or city/well water may then be emitted from the tap 130.

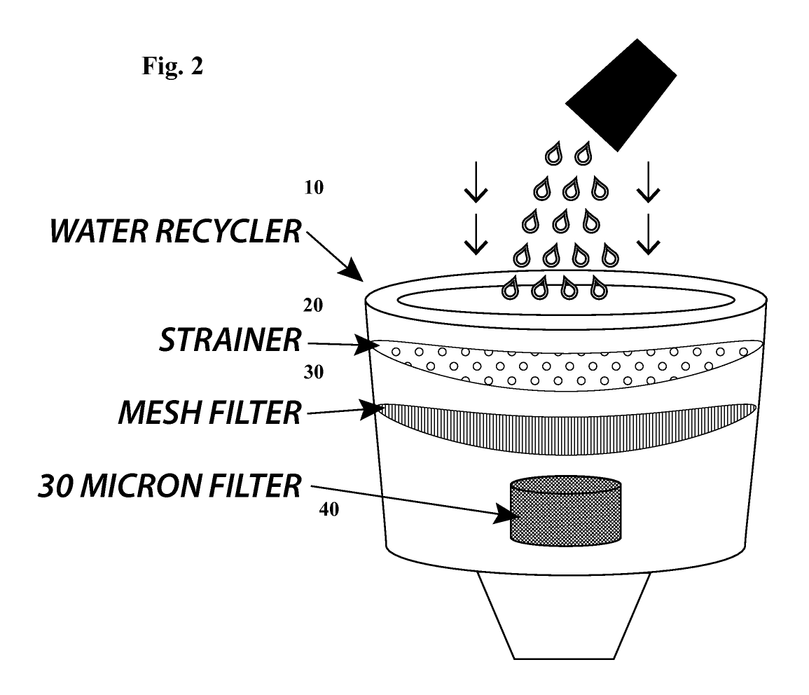

FIG. 2 is a magnified view of the receiving recycler 10 wherein a user can deposit liquids ranging from plain water to soda. A strainer 20 is placed to catch larger food debris prior then traveling through a mesh filter 30 which will catch smaller debris. Finally a thirty micron filter 40 is in-line and will catch debris which may be smaller than a user can see, and which will aid in optimum liquid flow throughout the system.

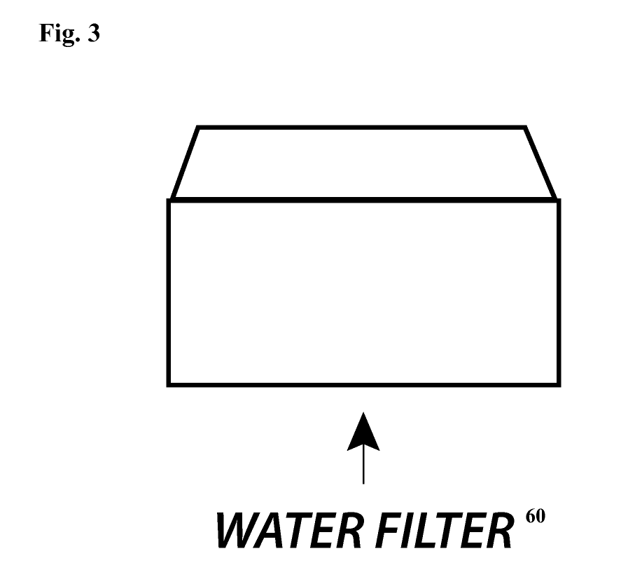

FIG. 3 is a generalized outline of a water filter 60. The filter provides pore-size efficiency suitable for general water filtration.

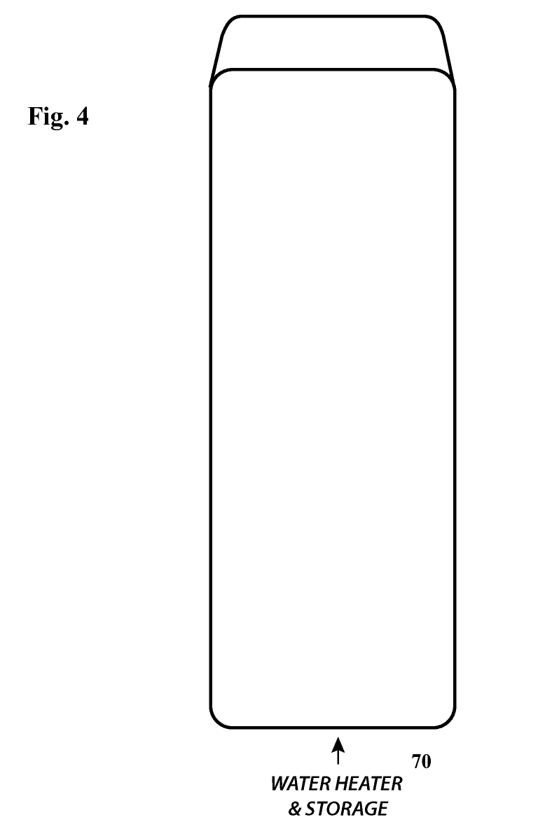

FIG. 4 is a generalized depiction of the water heater and storage unit 70. Standard thermostat controlled water heaters may be used in this process, and storage capability will depend on a user's needs and space allocated.

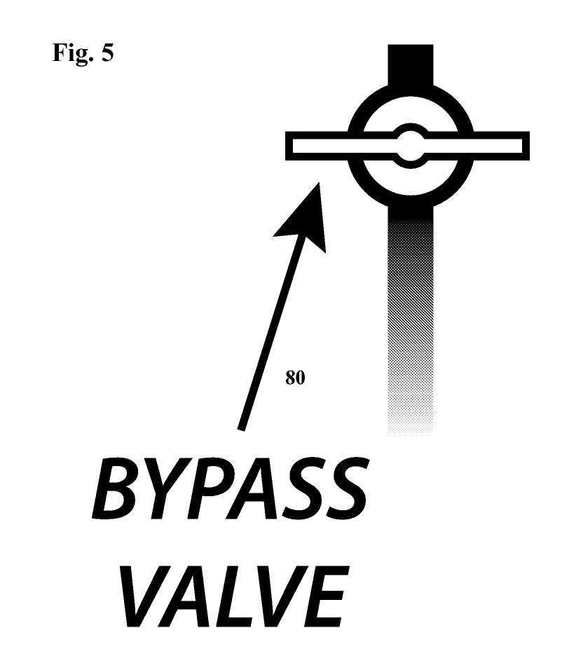

FIG. 5 is an illustration of a bypass valve 80 allows excess captured water, or overflow, to drain. The valve is a simple manually operated and auto actuated valve with easy recognition for open or closed positions. The valve is a simple manually operated valve with easy recognition for open or closed positions.

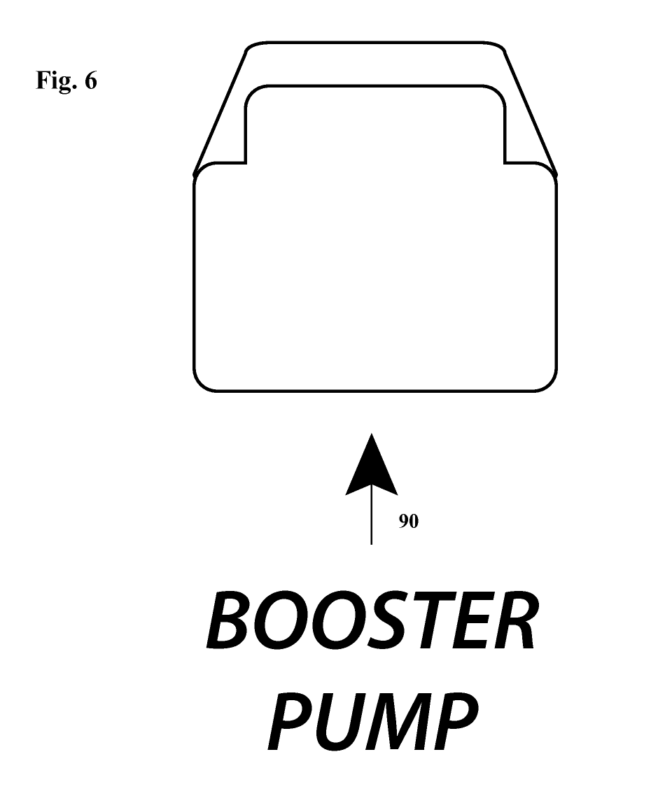

FIG. 6 is an illustration of the inventive system's booster pump 90. The pump is used to overcome low water pressure and aids in control of flow. The pump will house a pump motor, check valve, and pressure and flow sensor.

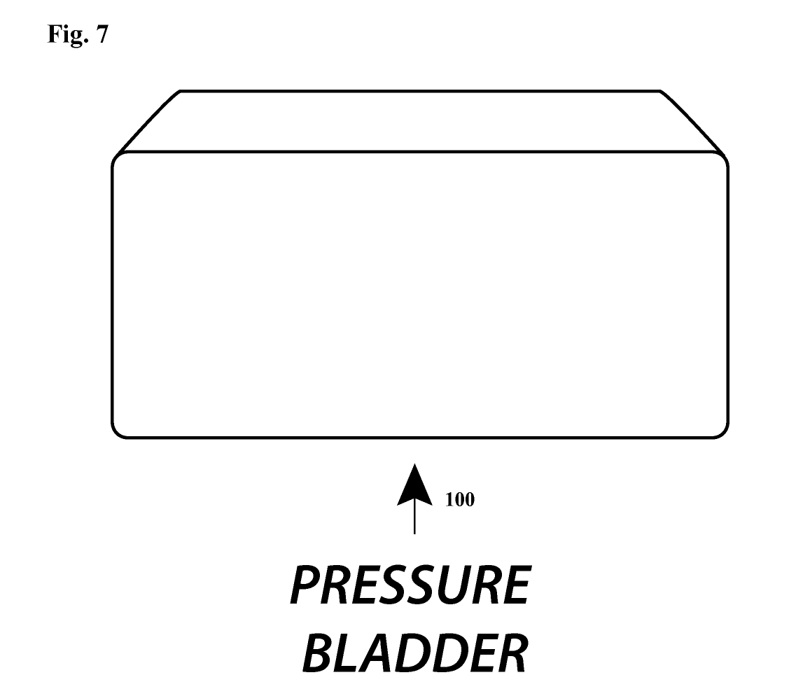

FIG. 7 illustrates a basic pressure bladder 100. Some booster pumps may have an internal bladder. The inventive system depicts an embodiment with a separate pressure bladder. A bladder is a balloon inside a tank that fills with water when there is pressure that is greater than that already in the bladder. A check valve stops the water from flowing backwards and reserves the water and pressure for use by the device it is feeding. This design may also eliminate the need for a pump, as the bladder will act as a pump that uses no power.

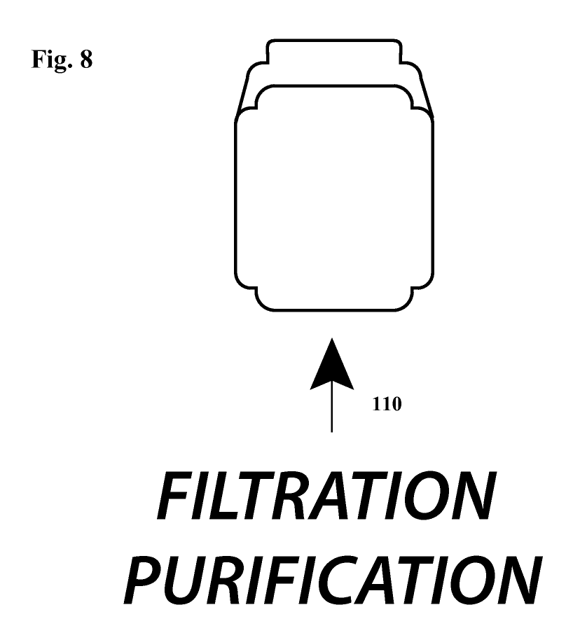

FIG. 8 illustrates a filtration purification module 110. Ordinary tap water can contain dissolved metals including lead and iron. It might contain nitrates, chlorine and mineral salts. A user's tap water could also contain other undesirable substances such as sulfates, mercury, asbestos and arsenic. This module refines the inventive system to further filter out particles from the processed recovered water.

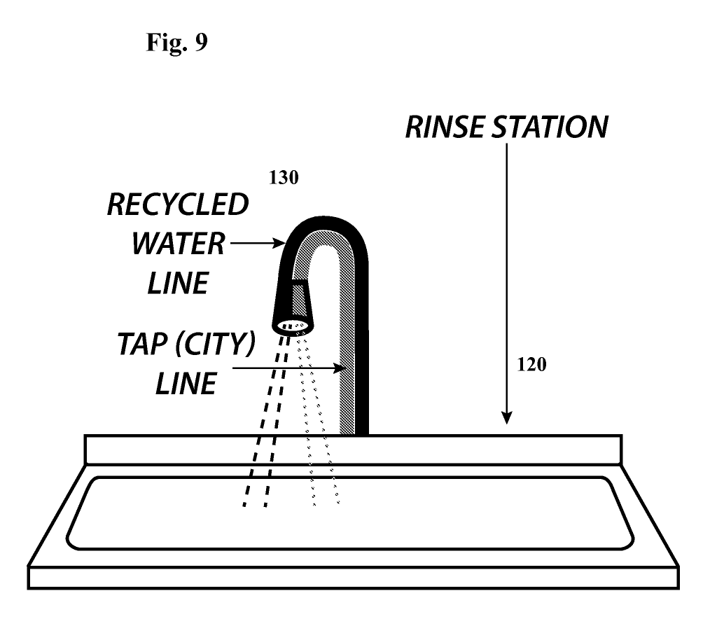

FIG. 9 illustrates a user's rinse station 120 wherein soiled dishes and cookware will be placed for pre-wash in typically a commercial grade dishwasher. The recovered water and city or well water are separated within individual water lines 130 so that the recovered water is isolated from any application except rinsing in the rinse station prior to commercial washing. Tap water can be switched on at the rinse station nozzle in the event the recovered water is depleted or unavailable.

1) A water and non-chemical liquid cleaning and recovery method and apparatus comprising;
a) a recycling basin with multiple filters
b) a first inline filtration module
c) a second inline filtration module
d) an inline water heating and storage module
e) an inline water bypass valve
f) an inline booster pump
g) an inline pressure bladder within a tank
h) an inline filtration purification module
i) a dual water pipe to separate city water and recovered water

2) A water and non-chemical liquid cleaning and recovery method and apparatus as in claim 1 wherein the recycling basin receives disposed liquids and processes liquid through a first filtration module comprising each of a strainer, mesh filter, and a 30 micron filter.

3) A water and non-chemical liquid cleaning and recovery method and apparatus as in claim 1 wherein a second inline filtration module cleans residual debris remaining from a first filtration process.

4) A water and non-chemical liquid cleaning and recovery method and apparatus as in claim 1 wherein the inline water bypass valve allows excess captured water, or overflow, to drain.

5) A water and non-chemical liquid cleaning and recovery method and apparatus as in claim 1 wherein the inline booster pump assists in pressure of recovered liquids through the bladder and tank.

6) A water and non-chemical liquid cleaning and recovery method and apparatus as in claim 1 wherein the inline pressure bladder maintains a desired range of water pressure in the distribution system.

7) A water and non-chemical liquid cleaning and recovery method and apparatus as in claim 1 wherein the inline purification and filtration module further removes debris and contaminants from recovered liquid or water.

8) A water and non-chemical liquid cleaning and recovery method and apparatus as in claim 1 wherein dual outlet water pipes run concentrically containing intake city or well water and recovered water as processed.
